(19) United States
(12) Patent Application Publication
(10) Pub. No.: US 2019/0080446 A1
(43) Pub. Date: Mar. 14, 2019

(54) SYSTEM AND METHOD FOR AUTOMATED DEFECT DETECTION

(71) Applicant: All Axis Robotics, LLC, Dallas, TX (US)

(72) Inventors: Gary Kuzmin, Plano, TX (US); David Perkowski, Plano, TX (US)

(21) Appl. No.: 16/127,998

(22) Filed: Sep. 11, 2018

Related U.S. Application Data
(60) Provisional application No. 62/556,874, filed on Sep. 11, 2017.

(51) Int. Cl. G06T 7/00; G06N 3/08; G06F 17/50; G06K 9/46; G06T 7/70; G06T 15/00

(52) U.S. Cl. CPC G06T 7/001; G06N 3/08; G06T 15/00; G06K 9/4604; G06T 7/70; G06F 17/5009

(57) ABSTRACT

The present invention relates in general to systems and methods for automating various aspects of defect detection, such as surface anomaly and foreign object and debris detection in workpieces fabricated from metallic or non-metallic materials.

### CROSS-REFERENCE TO RELATED APPLICATIONS

This patent application claims priority to U.S. Prov. Pat. App. Ser. No. 62/556,874, filed Sep. 11, 2017, which is hereby incorporated by reference for all purposes.

### BACKGROUND

### Technical Field

This invention relates in general to the field of workpiece fabrication and inspection, and more particularly, but not by way of limitation, to systems and methods for automating various aspects of defect detection in workpieces fabricated from metallic or non-metallic materials.

### Background

For many years, various mechanical and/or chemical processes have been used to fabricate workpieces from organic and/or inorganic materials. In general, inorganic materials may include metals and metal alloys and organic materials may include plastics, composites, insulators, and other like materials. The mechanical processes used to fabricate workpieces from such materials may include, but are not limited to, such operations as machining, milling, drilling, sawing, broaching, stamping, pressing, welding, laser cutting, sandblasting, water jet cutting, or other processes for fabricating workpieces. Chemical processes may include etching the workpiece with either wet or gaseous chemicals. Oftentimes, workpiece fabrication may include a combination of multiple different mechanical and chemical processes. For mechanical processes, oftentimes Computer Numerical Control (CNC) machines are utilized to automate the fabrication by means of computer-controlled machines executing pre-programmed sequences of control commands.

Oftentimes, workpiece modification techniques leave behind defects, such as surface anomalies and Foreign Object and Debris (FOD) on the surface of the workpiece being modified. The size and frequency of the FOD may vary depending on the fabrication process being used and the material being modified. In general, FOD is any substance, debris, or article alien to the final workpiece. Depending on the application, FOD may cause either immediate or future damage to the workpiece itself or the system the workpiece will be integrated into as a subcomponent thereof. For example, FOD may include raised or rolled edges and burrs or small pieces of material remaining attached to the workpiece after initial fabrication. In addition to rolled edges and burrs, other common defects elements may include crystals precipitated out of plating solutions, dirt, undissolved machining oils, and dust. In most cases, FOD is only detected via human intervention (i.e., inspection). Further, human intervention may also be required to map where the defects are located to allow for removal of the FOD.

There are three general types of burrs that may form from machining operations: Poisson burrs, rollover burrs, and breakout burrs. The rollover burr is the most common. Burrs may be classified by the physical manner of formation. Plastic deformation of material includes lateral flow (Poisson burr), bending (rollover burr), and tearing of material from the workpiece (tear burr). Solidification or redeposition of material results in a recast bead. Incomplete cut off of material causes a cut off projection.

Burrs, rolled edges, and other defects that are not corrected or removed from the finished workpiece can cause a myriad of problems. They can interfere with the seating and installation of fasteners, causing damage to the fasteners, components, or entire assemblies. Cracks caused by stress and strain can result in material failure. Burrs in holes also increase the risk of corrosion, which may be due to variations in the thickness of coatings on a rougher surface. Burrs in moving parts increase unwanted friction and heat. Rough surfaces may also result in problems with lubrication, as wear is increased at the interfaces of parts, making it necessary to replace them more frequently. Sharp corners tend to concentrate electrical charge, increasing the risk of static discharge. Electrical charge build-up can cause corrosion. In addition, metallic burrs that break free from workpieces installed into their final assembly may cause system failures and faults by shorting electrical circuits.

In general, projection burrs left on the surface of a workpiece can cause problems during finishing. First, they may result in surface imperfections in the surface of the workpiece, which may be revealed after a post machining protective finish (painting, powder coating, plating, etc.) is applied to the material. Second, depending on the shape of the burr, especially those with sharp points, the coverage of the protective finishing deposited on the burr will be minimal (as the given surface area is not conducive for coverage), increasing the risk of that area being susceptible to corrosion. Lastly, if the burr does get appropriately covered during the material finishing operation, but subsequently breaks away from the base material, it will expose the underlying metal, again resulting in the workpiece being subjected to potential future corrosion.

Consequently, each year, hundreds of millions of dollars are spent towards the prevention, detection, and removal of burrs in the final workpiece. FOD removal and especially deburring is a large consideration, and often problematic, for manufacturers. Many companies will claim that a part is produced “burr-free.” This is usually a fallacy as they may simply lack the equipment or expertise to support that claim. Even if a manufacturer contracts with FOD and/or deburring job shops that offer a turnkey solution for most deburring problems, there still lingers the question of how do they certify that the product they return is FOD free. Whether a company deburrs a workpiece internally or uses a deburring shop, how does the company inspect the parts to confirm removal of the FOD?

At times, certain levels of FOD resulting from a fabrication may be tolerable. Presently, no equipment exists to measure and classify the location and size of the FOD. With the current trend toward specialization, it has become virtually impossible for most companies to be experts in all aspects of producing their products and reliably insure that they can be sure that their product is FOD free. This goes for both manufacturers and consumers (e.g., OEM's).

Manufacturers employ many types of methods to eliminate FOD in their products as well as human resources to try and assure their customers that their products are free of FOD. This involves investment into deburring tools and equipment along with inspection resources. There is an entire industry built around the fabrication of part tumbling equipment intended to eliminate burrs and sharp edges. Even if a tumbler eliminates burrs without damaging other features of the workpiece, it does not eliminate the need to perform a final visual inspection. Unfortunately, when human resources are used to inspect for FOD, very little can be guaranteed as human resources fatigue quickly, are subjective, inefficient, and unreliable.

With respect to solutions to the above mentioned problems, in general, there are three classes of vision or quality inspection equipment in the marketplace today: optical comparators, optical/non-contact Coordinate-Measuring Machine (CMM) inspection systems, and microscopes. An optical comparator is an instrument that compares the silhouette of a part projected on a screen to allow an operator to view and inspect the dimensions and geometry of a workpiece measured against prescribed tolerances and limits. Optical comparators allow the operator to manually observe a burr and manually measure the burr using a system of grids visible on the projection screen, but burrs are not automatically detected.

Optical/non-contact CMM inspection systems can employ a variety of sensors such as Charge-Coupled Device (CCD) camera imaging, optics (most often in the visible white light spectrum), and laser interferometry. These machines are highly automated as the principle purpose of these vision inspection machines is to measure workpiece features (e.g., hole diameters, elevations, and other Cartesian and polar distances). The primary principle that each of these sensors depends on to function is feature edge detection of the workpiece being measured. The machines have built-in algorithms for determining the minimum acceptable edge detection in order to accurately measure the feature. If the edge is not detected or has less than the minimal threshold, operator intervention is required to determine the measurement. These machines cannot detect burrs, rather, they continue to measure parts even if burrs are present on the part. Burr detection requires operator intervention using optics to view any detected anomaly.

Microscopes are the most typical class of equipment employed by companies to inspect for burrs. Nearly all are manually operated and are thus very expensive to operate and are only as good as the operator who is performing the inspection. They have no built-in algorithms to automatically detect any features, including burrs. It is incumbent on the employer to train an operator to manually inspect for burrs. The employer must provide a training manual complete with images of various burr defects and burr definitions. These microscopes can come with cameras to document the size of burrs, but the location must be manually recorded. In general, these microscopes cannot measure the dimensions of the burrs unless they have been outfitted with an ocular reticle.

Currently, there is not an existing piece of equipment that is specifically designed to automatically inspect a workpiece for surface anomalies, while simultaneously detecting, identifying, and mapping the anomalies. Thus, there is a need for a system and method for automatically inspecting a workpiece in order to detect the presence of defects for subsequent remediation.

### SUMMARY OF THE INVENTION

In accordance with the present invention, systems and methods for automated defect detection in workpieces fabricated from metallic or non-metallic materials are provided. In accordance with one aspect of the present invention, a system is provided that uses a combination of optics, Cartesian and Polar movement, and software to automatically identify, detect, and locate (map) defects, such as FOD, surface anomalies, deviations from design specifications, dents, burrs, etc. In various embodiments, the optics may be capable of inspecting a feature of interest for defects from a wide range of Cartesian and Polar coordinates. For example, the system may include five-axis movement (in b-c-x-y-z axis) or may include more or less directions of movement. In some embodiments, the system may include attachments to mark and/or repair detected defects on manufactured workpieces, such as via laser, grinding, etc. In addition to defect detection and measurement, various embodiments may also detect defects due to abnormalities in the fabrication process (e.g., tool mismatches, over etching, etc.). It may do this, in part, by comparing what is detected to what is expected via, for example, 3D Computer Aided Design/Drafting (CAD) models.

In some embodiments, the system may also include software that uses machine learning and pattern recognition to identify both regularities and irregularities in data. More specifically, in such embodiments, the system may be trained or taught to recognize the presence of different types of defects and added to the learning database for future recognition and filtering. For example, detected defects can be measured and filtered as a PASS, FAIL, or INDETERMINATE (LEARN) depending on the criteria established by the specification. Indeterminate findings can be made to learn and allow for manual intervention to determine future PASS or FAIL criteria. The advantages of such embodiments may include improved speed of inspection by reducing the need for costly and time-consuming visual inspection and may also include improved accuracy of inspection by achieving a consistent inspection methodology controlled by software and consistently inspect in difficult to view locations, such as a blended radius at intersections and/or blind holes. Various embodiments may also improve repair of workpieces by identifying and mapping locations where defects are located for subsequent remediation, especially those in otherwise inaccessible, hard to see locations, or shear number of similar features making it difficult to separate positive and negative results (e.g., a part may have a random pattern of 50 holes of various diameters). Various embodiments may also ensure that all defects are consistently identified, classified, and tagged on every part to increase quality and reliability of parts.

Typically, defects (including FOD, burrs, and other surface anomalies) by their very nature are non-uniform in appearance and mass. The variation has to do with the fabrication method of the workpiece and the variables associated with the fabrication. As such, because their pattern is irregular and random, they cannot be detected by current commercially available vision inspection systems. In various embodiments, the present system may include pattern recognition deviation instead of or in addition to pattern matching.

The above summary of the invention is not intended to represent each embodiment or every aspect of the present invention. Particular embodiments may include one, some, or none of the listed advantages.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a five-axis surface anomaly detection device in accordance with one embodiment of the present invention;

FIG. 2 illustrates a robotic arm in accordance with one embodiment of the present invention;

FIG. 3 illustrates an end of a robotic arm to which an optical device may be attached;

FIGS. 4a and 4b illustrate an optical device inspecting a hole at different angles;

FIG. 5 illustrates a preprogrammed pattern for hole inspection;

FIG. 6 is a flow chart of a method according to an embodiment of an automated defect detection method; and

FIG. 7 is a flow chart of a method according to an embodiment of an automated defect detection method.

### DETAILED DESCRIPTION

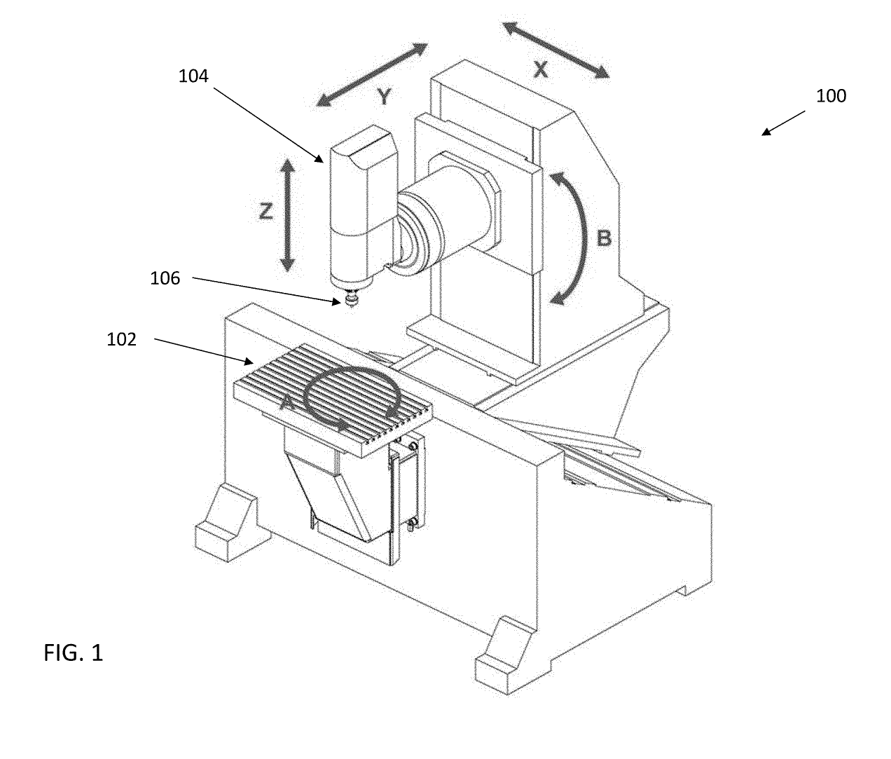

In accordance with the present invention, systems and methods for automated surface anomaly detection in workpieces fabricated from metallic or non-metallic materials are provided. Referring now to FIG. 1, an embodiment of an automated surface anomaly detection system 100 is provided having a workpiece inspection platform 102; a robotic arm 104; an optical detection system including an optical device 106 and an accompanying lighting system; and accompanying software and hardware. The workpiece inspection platform 102 provides a stable surface onto which a workpiece to be inspected may be mounted. Although the embodiment in FIG. 1 shows the platform 102 as movable, oftentimes the platform is stationary and the robotic arm 104 is movable relative to the platform. Oftentimes, the platform 102 consists of a large granite slab or other relatively immobile surface having a plurality of holes therein. The workpiece to be inspected may be secured to one or more of the holes to provide stability during the inspection process. In some embodiments, the platform 102 may include a conveyor belt and the workpieces may be secured to the conveyor belt. In other embodiments, the system may automatically determine a location and/or orientation of the workpiece and/or the workpiece may not be secured to the platform.

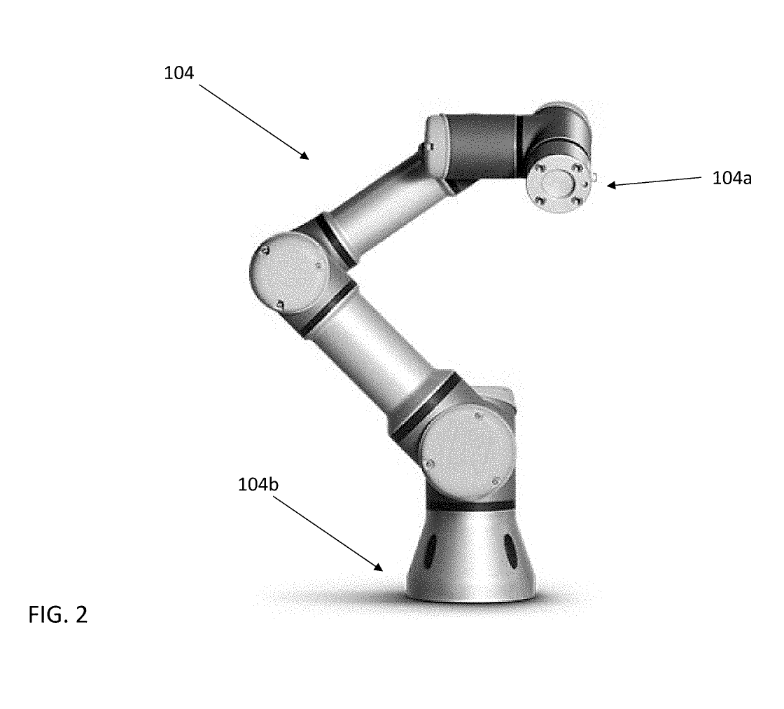

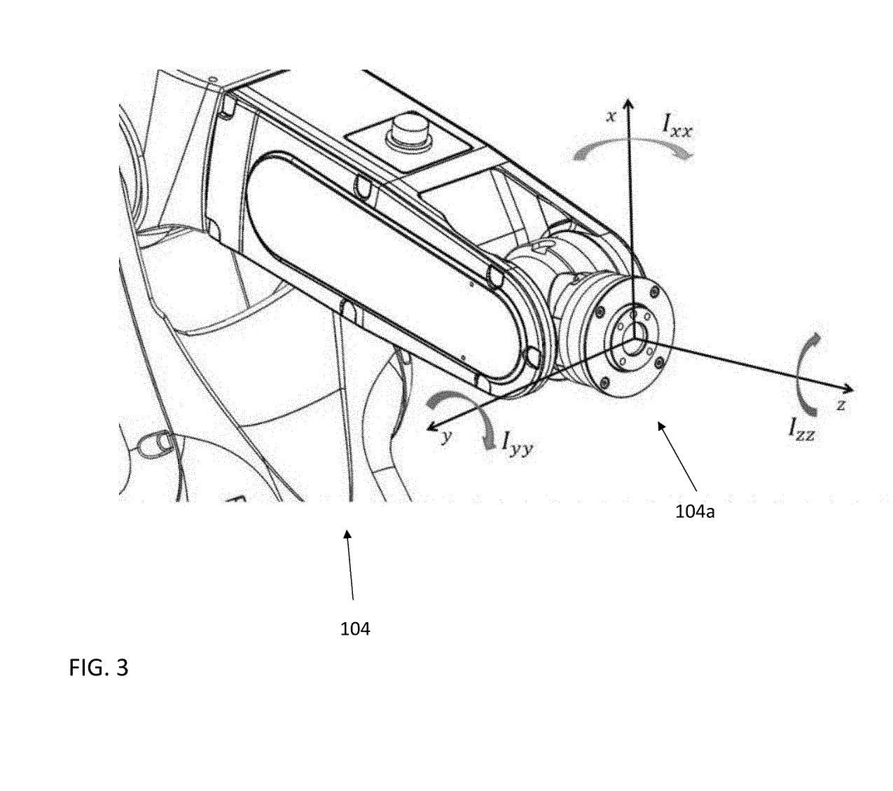

Referring now to FIG. 2, an embodiment of a robotic arm 104 is provided. In the embodiment shown, the robotic arm 104 has numerous degrees of freedom so that its base end 104b may remain immobile while its inspection end 104a may be moved to any of a number of Cartesian or Polar coordinates to inspect a workpiece. Referring now to FIG. 3, an embodiment of the inspection end 104a of the robotic arm 104 is provided. In the embodiment shown, the inspection end 104a has a plurality of degrees of freedom to allow the optical inspection device to be rotated along multiple axes.

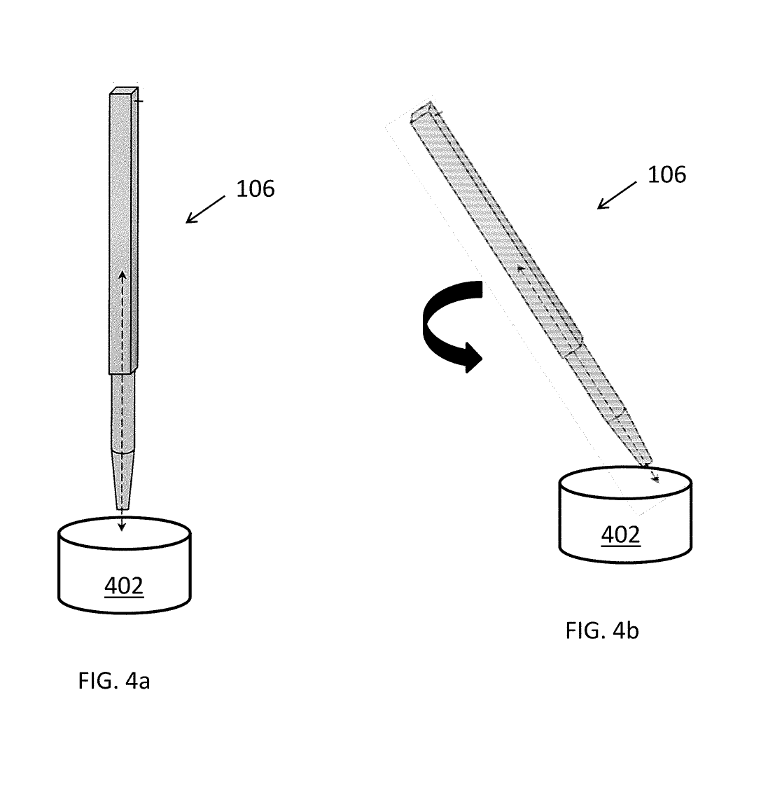

Referring now to FIGS. 4a and 4b, the optical device 106 of the optical detection system is shown inspecting an upper edge and inner surface of a hole 402 of a workpiece (not shown). The optical detection system may include a CCD or megapixel digital camera or visible light lens and may have a fixed or variable magnification and/or focal length. A lighting system may be included, such as, a co-axial light for optimized surface lighting, a ring light for lateral illumination, a back light for high contrast feature illumination, or a combination of one or more of the foregoing. Oftentimes, defects, such as FOD and surface anomalies, may be located on an inner or underside surface of a hole, rather than on a top edge of the hole. In such embodiments, the optical device 106 may need to view the hole 402 at a plurality of angles. As can be seen in FIG. 4a, the optical device 106 is inspecting the hole 402 along an axis of the hole 402. The optical device 106 may be moved closer to the hole 402, around the edge of the hole 402, inserted into the hole 402, or positioned in any other manner relative to the hole 402 in order inspect the various surfaces and edges of the hole 402 for defects. In some embodiments, it may be beneficial to view the inner surface of the hole 402 at an angle relative to the axis of the hole 402. As can be seen in FIG. 4b, the optical device 106 has been angled relative to the axis of the hole 402. From there, the optical device may be rotated around to view the entire inner surface of the hole 402. In some embodiments, the optical device 106 may be rotated up to, for example, 180 degrees, while in other embodiments, the optical device 106 may be rotated up to, for example, 360 degrees. In other embodiments, the field of view of the optical device 106 may be modified relative to the position and/or orientation of the optical device 106. For example, the field of view could be zoomed in or zoomed out rather than moving the optical device 106 closer to or further away from a surface being inspected. In some embodiments, the field of view of the optical device 106 may be projected to a side of the optical device 106 such that the optical device 106 may be inserted into the hole 402 and the field of view rotated to view the inner surface (or a back surface) of the hole 402 without having to change the angle of the optical device 106 relative to the hole 402. In some embodiments, the field of view of the optical device 106 may be rotated without having to rotate the entire optical device 106.

In some embodiments, the optical device 106 may capture a first image of a surface edge of a first hole 402 on a first workpiece having no detectable defects. The optical device 106 may capture a second image of a surface edge of a first hole 402 on a second workpiece having FOD at a location on the surface edge thereof. The system may compare the first image with the second image to detect the presence of FOD on the second workpiece. The second image may be stored in a database of images of defects. The optical device 106 may then capture a third image of a surface edge of a different hole having FOD on the surface edge thereof on a third workpiece of a different type than the first and second workpieces. The third image may be compared to the images in the database of images of defects to detect the presence of FOD on the third workpiece.

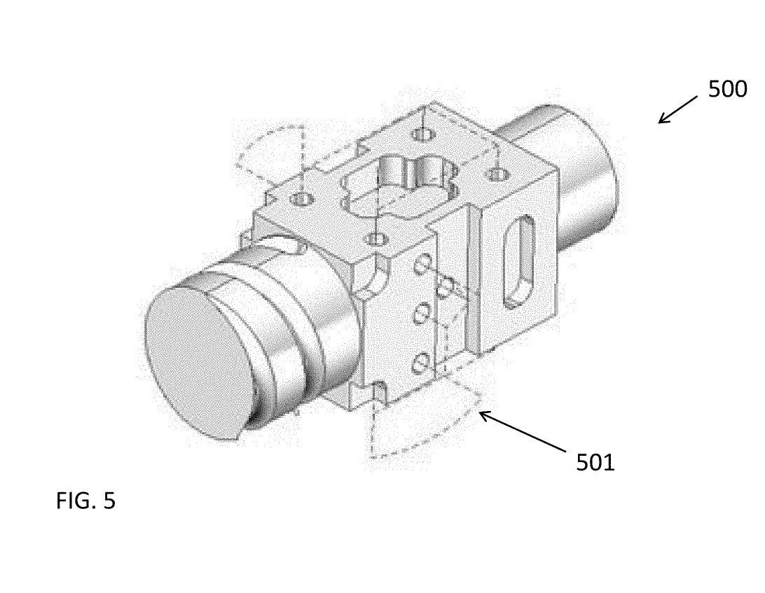

Referring now to FIG. 5, a pre-programmed path 501 around a workpiece 500 is shown. In some embodiments, the workpiece 500 may be secured to the inspection platform 102 and the robotic arm 104 may move the optical device 106 along the pre-programmed path 501 to inspect various features of the workpiece 500. In the pre-programmed path 501 shown, the optical device 106 is inspecting various aspects of holes in the workpiece 500.

Software, running on one or more processors, drives the pattern recognition, system training, and learning. In some embodiments, the processors may be located on custom built computers that interface with the workpiece inspection platform and optics detection system with the ability to capture and store results of an inspection session. Prior sessions may be replayed for further detailed analysis and documentation. In some embodiments, the system may include a laser, drill, grinder, or other tool for correcting detected anomalies.

Generally speaking, in various embodiments, the software may incorporate machine learning focused on the recognition of patterns and regularities in data. In various methods of using the system, a process of supervised learning may be included to “train” the software to recognize surface anomalies using labeled training data. In order to create the labeled training data, a set of features may need to be properly labeled by hand with the correct output. To maximize the recognition rates, the machine learning process may be carried out initially prior to delivery of the system to a customer and/or may be carried out by each customer after installation of the system. In some embodiments, a plurality of automated identification systems may be coupled together, for example, via the Internet, and may share all or part of the training data to improve the pattern recognition of each of the systems. In some embodiments, the method may include an unsupervised learning process in which the software attempts to find inherent patterns in the features that can then be used to determine the correct output value for new data instances. For example, the system may inspect a workpiece with dozens of holes and may identify out-of-compliance holes that are inconsistent with the majority of the holes. Some embodiments may utilize semi-supervised learning, which uses a combination of labeled and unlabeled data (typically a small set of labeled data combined with a large amount of unlabeled data). In some embodiments, the software may be configured to classify or cluster groups of features having similarities and then an operator may determine whether the groups pass or fail.

In some embodiments, the software may be configured to assign a label to a given feature being inspected, such as “PASS” or “FAIL.” In other embodiments, the software may assign a real-valued output to a given feature begin inspected, such as the size of a hole being measured rather than simply an indication of whether the hole is within a predetermined tolerance threshold. In various embodiments, in addition to or instead of looking for exact matches in the input with pre-existing patterns, the software may be configured to perform a “most likely” matching of the inputs, taking into account their statistical variation.

In various embodiments, a feature of a workpiece to be inspected may be broken out into a plurality of characteristics, which may be categorical, ordinal, integer-valued, or real-valued, and the software may be configured to use statistical inference to find the best label for a given instance and/or a probability of the instance being described by the given label. Benefits include outputting a confidence value associated with a choice or abstaining when the confidence of choosing any particular output is too low. Probabilistic pattern-recognition algorithms can be more effectively incorporated into larger machine-learning tasks, in a way that partially or completely avoids the problem of error propagation. In some embodiments, the software may include a feature extraction algorithm and/or a feature selection algorithm to prune out redundant or irrelevant features.

In various embodiments, the software may include deep learning (also known as deep structured learning or hierarchical learning) as part of the machine learning methods based on learning data representations, as opposed to task-specific algorithms. Such learning may be supervised, partially supervised, and/or unsupervised. Deep learning is a class of machine learning that uses a cascade of many layers of nonlinear processing units for feature extraction and transformation. Each successive layer uses the output from the previous layer as input. In some embodiments, the deep learning incorporates (1) multiple layers of nonlinear processing units and (2) the supervised or unsupervised learning of feature representations in each layer, with the layers forming a hierarchy from low-level to high-level features. The composition of a layer of nonlinear processing units used in a deep learning algorithm depends on the problem to be solved. Deep learning adds the assumption that these layers of factors correspond to levels of abstraction or composition. Varying numbers of layers and layer sizes can provide different amounts of abstraction. Deep learning exploits this idea of hierarchical explanatory factors where higher level, more abstract concepts are learned from the lower level ones. Deep learning helps to disentangle these abstractions and pick out which features are useful for improving performance and detection. For supervised learning tasks, deep learning methods obviate feature engineering, by translating the data into compact intermediate representations akin to principal components, and derive layered structures that remove redundancy in representation. Deep learning algorithms can be applied to unsupervised learning tasks.

In some embodiments, the deep learning may include artificial neural networks (ANN), which learn (progressively improve performance) to do tasks by considering examples, generally without task-specific programming. For example, in image recognition, they might learn to identify images that contain burrs by analyzing example images that have been manually labeled as “burr” or “no burr” and using the analytic results to identify burrs in other images. Some embodiments may include the use of a deep neural network (DNN), which is an ANN with multiple hidden layers between the input and output layers. DNNs can model complex non-linear relationships. DNN architectures generate compositional models where the object is expressed as a layered composition of primitives. The extra layers enable composition of features from lower layers, potentially modeling complex data with fewer units than a similarly performing shallow network. DNNs are prone to overfitting because of the added layers of abstraction, which allow them to model rare dependencies in the training data. Regularization methods can be applied during training to combat overfitting.

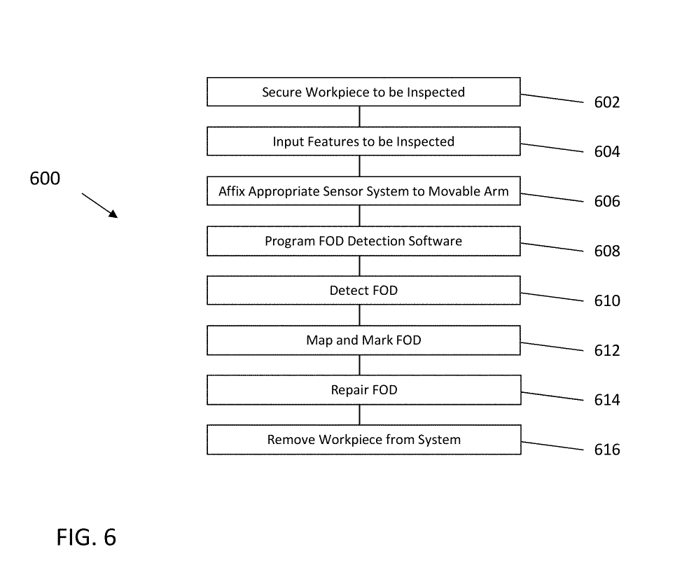

Referring now to FIG. 6, a method 600 of operation of an embodiment of an automated workpiece inspection system is provided. At step 602, a workpiece to be inspected is placed on a table or fixture. In a preferred embodiment, a fixture may be used that allows the optic detection system to have access to the entirety of those portions of the part needing to be inspected to eliminate multiple setups. Next, at step 604, the Cartesian platform (in the case a collaborative robot) with the software is programmed to teach the robot machine what features on the part need to be inspected. Next, at step 606, the appropriate sensor system is affixed to the Cartesian moment generator (in this case a robotic arm) and the appropriate lighting system is selected and attached, if needed, to the robotic arm for the features to be inspected. At step 608, the defect detection software is programmed. This may be done by learning and/or selecting an appropriate library. Once defects are detected at step 610, it can be mapped and marked for future disposition, classification, remediation, or eradication either through manual methods or automatically through integrated eradicated methods at step 612. These steps may include the machine applying a marker (e.g., spray an ink dot on the workpiece) to mark the location of the defect for manual verification. Once a mark has been applied, the machine may move onto the next inspection point or may pause (and send a signal) to allow the operator to manually verify, classify, and/or fix. At step 614, the machine may attempt to repair the identified defect. In some embodiments, the software may be configured for either manual repair or automatic repair depending on the type of imperfection detected. For example, various embodiments may release a jet of air or other stream to blow-off the FOD and then re-inspect, and continue or pause and wait for training classification. In some embodiments, an integrated laser beam can be triggered and directed to attempt to vaporize the FOD. After the attempt to remediate, re-inspection occurs and, if it passes, continues to inspect or pause and allow operator intervention and classification. Finally, after the workpiece has been fully inspected, the workpiece is removed from the inspection platform at step 616.

In various embodiments, the method 600 is able to detect a plurality of different types of defects including FOD, burrs, indentations on an edge of a workpiece, rolled edges, cracks, steps, grooves, and other variations from the design specifications. In various embodiments, the method is able to detect defects that are not technically FOD, such as surface anomalies caused by an incomplete machining process. In some embodiments, after a defect has been detected, such as a burr located on an inner edge of a through hole, the method may send a signal to an operator and then pause to allow the operator to manually place a visual indicator in the vicinity of the defect to aid in remediation. In a preferred embodiment, the automated inspection method may include a means for marking detected imperfections, such as a dye, marker, or other mark. In some embodiments, the method may simply electronically record the location of the imperfection for later remediation or may remediate the imperfection during the inspection process, either by pausing the inspection or by remediating simultaneously. In some embodiment, the method may include taking a photograph of the defect on the workpiece to aid in remediation. In some embodiments, the method may include overlaying a grid or other coordinates to show where the deviation has occurred. In some embodiments, the method may be able to identify a shoulder that deviated from the design specifications, tooling marks in or around edges and/or the bottom of a hole, a step where the design specifications called for a surface to be flat, and/or cracks in the surface or under the surface of the workpiece.

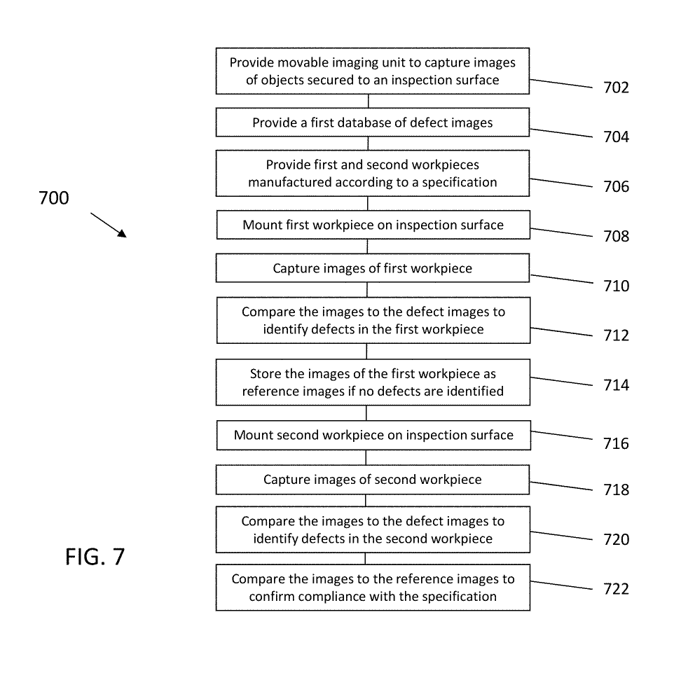

Referring now to FIG. 7, a method 700 of operation of an embodiment of an automated workpiece inspection system is provided. At step 702, the method begins by a user providing an imaging unit configured to capture images of three-dimensional objects secured to an inspection surface as the imaging unit moves relative to the inspection surface. At step 704, a first database of defect images is provided, the defect images corresponding to defects identified in three-dimensional workpieces having features similar to, but not necessarily identical to, the features of the first and second workpieces. At step 706, first and second workpieces are manufactured according to a common specification, the first and second workpieces having a plurality of features. At step 708, the first workpiece is mounted at a location on the inspection surface. At step 710, a plurality of images of the first workpiece are captured as the imaging unit moves through a predetermined path, wherein a first feature of the first workpiece is captured by a first image. At step 712, the plurality of images of the first workpiece are compared to the images of generic defects to identify defects in the first workpiece. At step 714, the plurality of images of the first workpiece are stored in a second database of reference images if no defects are identified. At step 716, the second workpiece is mounted at the location on the inspection surface. At step 718, a plurality of images of the second workpiece are captured as the imaging unit moves through the predetermined path, wherein the first feature of the second workpiece is captured by a second image. At step 720, the plurality of images of the second workpiece are compared to the images of generic defects to identify defects in the second workpiece. At step 722, the second image is compared with the first image to confirm the first feature of the second workpiece is in compliance with the specification.

Importantly, many of the inspection methods currently utilized would not detect these imperfections. For example, one common inspection method is a touch sensor that is programmed to touch a plurality of surfaces around the workpiece to confirm each of the surfaces is properly dimensioned. Oftentimes, the touch sensors do not inspect the entire surface area of a flat surface, instead only touching the outer edges. In such a situation, a step or burr in the middle of a flat surface would not be detected. However, the pattern recognition method employed in various embodiments of the present invention would be designed to detect such an anomaly. As another example, the touch sensor would likely not detect the tooling marks in the bottom of a hole. Rather, the touch sensor would likely confirm that the hole was dimensioned correctly and not flag the imperfection. Similarly, hairline cracks are often not detected by most touch sensors. In the past, the only reliable way to detect such defects is by having a human visually inspect each aspect of each part under very high magnification. However, humans can only inspect workpieces for a limited period of time before their error rate increases significantly. In addition, human inspection is inherently subjective. The present invention attempts to overcome these drawbacks by providing a reliable, consistent, repeatable, automated inspection system and method.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications, and substitutions without departing from the spirit and scope of the invention.

What is claimed is:

1. A method of detecting a defect in a three-dimensional workpiece, the method comprising:
providing an imaging unit configured to capture images of three-dimensional objects secured to an inspection platform as the imaging unit moves relative to the inspection platform;
providing first and second workpieces manufactured according to a specification, the first and second workpieces having a plurality of features;
providing a first database of defect images, the defect images corresponding to defects identified in three-dimensional workpieces having features similar to the plurality of features of the first and second workpieces;
mounting the first workpiece at a location on the inspection platform;
capturing a plurality of images of the first workpiece as the imaging unit moves through a predetermined path; wherein a first feature of the first workpiece is captured by a first image;
comparing the plurality of images of the first workpiece to the defect images to identify defects in the first workpiece;
storing the plurality of images of the first workpiece in a second database of reference images if no defects are identified;
mounting the second workpiece at the location on the inspection platform;
capturing a plurality of images of the second workpiece as the imaging unit moves through the predetermined path, wherein the first feature of the second workpiece is captured by a second image;
comparing the plurality of images of the second workpiece to the defect images to identify defects in the second workpiece; and
comparing the second image with the first image to confirm the first feature of the second workpiece is in compliance with the specification.

2. The method of claim 1, wherein the imaging unit is mounted to a robotic arm having at least five degrees of freedom.

3. The method of claim 1 and further comprising:
mapping a position of the first feature.

4. The method of claim 1, and further comprising:
creating a three-dimensional computer model of the first workpiece; and
generating the predetermined path based on the three-dimensional computer model of the first workpiece.

5. The method of claim 1, and further comprising:
providing a material removal tool configured to remove material from objects mounted to the inspection platform; and
correcting identified defects using the material removal tool.

6. The method of claim 1, and further comprising:
providing a marking tool configured to place visual markers on objects mounted to the inspection platform; and
placing a visual marker proximate to identified defects using the marking tool.

7. The method of claim 1, wherein the first feature of the second workpiece needs remediation when a difference between the second image of the first feature and the first image of the first feature is greater than a predetermined amount.

8. A method for detecting a defect in a three-dimensional workpiece, the method comprising:
providing an imaging unit having a field of view, the imaging unit configured to capture images of objects secured to an inspection platform;
mounting the imaging unit to a robotic arm, the robotic arm configured to facilitate three-dimensional movement of the imaging unit relative to the inspection platform;
mounting a three-dimensional workpiece to a location on the inspection platform, the three-dimensional workpiece having a plurality of features;
moving the imaging unit through a predetermined path about the three-dimensional workpiece;
capturing a plurality of images of the three-dimensional workpiece as the imaging unit moves through the predetermined path, wherein each feature of the plurality of features is captured by at least one image;
detecting defects in the three-dimensional workpiece by comparing the plurality of captured images with reference images stored in an image database;
identifying a position of each detected defect, the position corresponding to a feature of the plurality of features; and
storing the position of each of the detected defects.

9. The method of claim 8 and further comprising:
creating a three-dimensional computer model of the three-dimensional workpiece; and
generating the predetermined path based on the three-dimensional model of the three-dimensional workpiece.

10. The method of claim 9 and further comprising:
creating a map of the features of the three-dimensional workpiece, wherein the predetermined path is automatically generated based at least in part on the map of the features.

11. The method of claim 8 and further comprising:
wherein the three-dimensional workpiece comprises a hole bored therein, the hole having a cylindrical sidewall; and
wherein the predetermined path includes rotating the field of view of the imaging unit to capture images of the cylindrical sidewall of the hole.

12. The method of claim 8, wherein the defects are detected using a machine learning based process.

13. A system for detecting defects in objects, the system comprising:
an inspection platform configured to have a three-dimensional workpiece mounted thereon;
an imaging device adapted to capture images of the three-dimensional workpiece, the imaging device being movable relative to the inspection platform;
a controller coupled to the imaging device, the controller including a processor and a memory, the controller configured to:
receive specifications for the three-dimensional workpiece, the specifications including desired dimensions of features of the three-dimensional workpiece;
command the imaging device to move along a predetermined path to capture images of the three-dimensional workpiece;
calculate actual dimensions of the features of the three-dimensional workpiece;
detect a defect in the three-dimensional workpiece when an actual dimension of a feature of the features is not identical to a desired dimension of the feature; and
calculate a location of the defect on the three-dimensional workpiece.

14. The system of claim 13, wherein the imaging device is mounted to a robotic arm having at least five degrees of freedom.

15. The system of claim 13 and further comprising:
a material removal tool configured to remove material from objects mounted to the inspection platform, the material removal tool being coupled to the processor and configured to receive remediation instructions from the processor to correct the detected defect in the three-dimensional workpiece.

16. The system of claim 14, wherein a material removal tool is mounted to the robotic arm.

17. The system of claim 13 and further comprising:
a marking tool configured to place visual markers on objects mounted to the inspection surface, the marking tool being coupled to the processor and configured to receive marking instructions from the processor to place a visual marker proximate to the location of the defect on the three-dimensional workpiece.

18. The system of claim 13, wherein the detected defect is identified as needing remediation when a difference between the actual dimension of the feature and the desired dimension of the feature is greater than a predetermined amount.

19. The system of claim 13, wherein the controller detects the defect by comparing an image of the feature with a reference image stored in the memory.

20. The system of claim 19, wherein the controller is further configured to categorize the defect by defect type.
